(19) United States
(12) Patent Application Publication
(10) Pub. No.: US 2007/0153778 A1
(43) Pub. Date: Jul. 5, 2007

(54) Synchronous packetization interval for audio packets

(76) Inventors: Ajaykumar R. Idnani, Schaumburg, IL (US); Kamala D. Urs, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/324,543

(22) Filed: Jan. 3, 2006

(51) Int. Cl. H04L 12/66

(52) U.S. Cl. 370/356

(57) ABSTRACT

A method of synchronizing packet rates in a voice over internet protocol system in accordance with one embodiment comprising sending a first parameter from an offering node (100) to an answering node (104), the first parameter indicative of a first rate at which the offering node wants to receive packets (300); and sending a second parameter from the offering node to the answering node, the second parameter indicative of a second rate which the offering node wants to send packets (302).

### BACKGROUND OF THE INVENTION

1. Field of the Invention

The present invention relates to audio packets. More specifically, the present invention relates to synchronous packetization interval for audio packets in Voice-Over-Internet-Protocol (VoIP).

2. Discussion of the Related Art

In VoIP systems, generally the Session Initiation Protocol (SIP) uses an offer/answer model using Session Description Protocol (SDP) to negotiate the media specifics that will be used in sending packets back and forth between two nodes. The media specifics include, for example, the codec to use and the port for receiving audio packets. As part of this negotiation the packetization interval of the audio packets also gets negotiated between the two nodes. The packetization interval indicates the time interval for which each node would like to receive packets, e.g., every 10 milliseconds or 20 milliseconds. The packetization interval is designated by a parameter “ptime.”

For the two nodes that are going to be communicating in the VoIP system, one node is an offerer and the other node is the answerer. When negotiating a session initiation the offerer sends the ptime parameter (e.g., 20 msecs) to the answerer. Similarly, the answerer sends the ptime parameter (e.g., 10 msecs) back to the offerer. In current systems, there is no requirement that the ptime parameters are equal for the offerer and the answerer. Many nodes in a VoIP system are wired (e.g., a home computer) and therefore having different send and receive packetization intervals is not a problem. This is because energy consumption for a wired node is generally not a problem. However, for wireless nodes, such as cellular telephones or Personal Digital Assistants, having different packetization intervals can use a lot of extra battery power which is at a premium. For example, if a wireless node is communicating with a wired node and the wireless node is only sending packets every 20 msecs and the wired node is sending packets every 10 msecs, the wireless node is going to have to wake up every 10 msecs in order to receive all of the packets from the wired node. The wireless node, however, is only sending a packet every other time that it wakes up. This is very inefficient for the wireless node and drains more of the battery power than necessary.

One additional problem with the current system is that the offerer and the answerer are not required to actually send packets at the packetization interval received from the other node. For example, an offerer can send a ptime parameter indicating that the offerer would like to receive packets every 20 msecs. In response, the answerer can send packets every 10 msecs even though the offerer requested packets to be sent every 20 msecs. Therefore, the current system has no way of ensuring that the packetization interval for both nodes is equivalent.

### BRIEF DESCRIPTION OF THE DRAWINGS

The features and advantages of the present invention will be apparent from the following description thereof, presented in conjunction with the following drawings, wherein:

FIG. 1 is a block diagram illustrating a voice over internet protocol (VoIP) system in accordance with one embodiment;

FIG. 2 is a timing diagram illustrating a negotiation for setting up a VoIP session between two nodes in accordance with one embodiment;

FIG. 3 is a flow diagram illustrating a method of synchronizing packet interval rates in accordance with one embodiment;

FIG. 4 is a flow diagram illustrating a method of synchronizing packet interval rates in accordance with another embodiment; and

FIG. 5 is a flow diagram illustrating a method of synchronizing packet interval rates in accordance with yet another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

The embodiments described herein provide methods for ensuring that two nodes communicating over a VoIP network will have equal send and receive packet interval rates.

One embodiment can be characterized as a method of synchronizing packet rates in a Voice over Internet Protocol system comprising sending a first parameter from an offering node to an answering node, the first parameter indicative of a first rate at which the offering node wants to receive packets, and then sending a second parameter from the offering node to the answering node, the second parameter indicative of a second rate by which the offering node wants to send packets.

Another embodiment can be characterized as a method of synchronizing packet rates in a Voice over Internet Protocol system comprising receiving a first parameter at an answering node from an offering node, the first parameter indicative of a first rate at which the offering node wants to receive packets, and receiving a second parameter at the answering node from the offering node, the second parameter indicative of a second rate at which the offering node wants to send packets.

Yet another embodiment includes a method of synchronizing packet rates in a Voice over Internet Protocol system comprising receiving a first parameter at an answering node from an offering node, the first parameter indicative of a first rate at which the offering node wants to receive packets, determining the first rate at which the offering node wants to receive packets, determining a second rate at the answering node based upon the first rate at which the offering node wants to receive packets, the second rate being equal to the first rate, and sending a second parameter from the answering node to the offering node, the second parameter indicative of the second rate at which the answering node wants to receive packets.

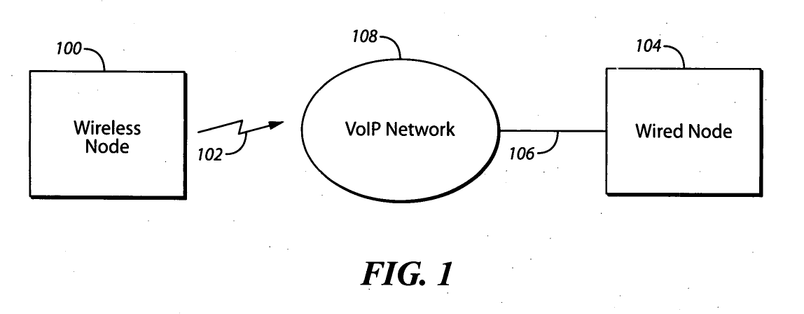

Referring to FIG. 1 a block diagram is shown illustrating a Voice over Internet Protocol (VoIP) system in accordance with one embodiment. Shown is a wireless node 100, a wireless interface 102, a wired node 104, a wired interface 106 and a network 108.

The wireless node 100 is connected to the network 108 through the wireless interface 102. The wired node 104 is connected to the network 106 through the wired interface 106. The wireless node 100 is, for example, a wireless telephone, a computer, a personal digital assistant or other similar type device that is powered, at least in part, by a battery and can connect to the network 106 through the wireless interface. The wired node in the present example is, for example, a home computer or other device that is powered, for example, from a standard 120 volt outlet and can connect to the network 108 through, for example, the wired interface 106. It should be understood that the system shown in FIG. 1 is but one example of a VoIP system and many other embodiments are also contemplated herein. The network is, for example, a VoIP network or other digital network through which audio packets are sent.

In a first example of a negotiation process for initiating a VoIP session, the wireless node 100 is an offerer and the wired node 104 is an answerer (i.e., the wireless node 100 requests the session and the wired node 104 responds to the requests). When starting a session, one of the parameters that the offerer (i.e., wireless node 100) sends to the answerer is a parameter “ptime” that indicates a rate at which the offerer would like to received audio packets. The parameter “ptime” is known and used in prior systems. In accordance with the present embodiment, the offerer also sends a second parameter, for example “send-ptime,” that indicates a rate at which the offerer would like to send packets.

In the present example, the wireless node 100 is the offerer and would like to have the rate at which it receives packets be equal to the rate at which it sends packets. Advantageously, having equal send and receive rates allows the wireless node to wake up, send a packet and receive a packet, and then resume a power saving state. This conserves the battery power of the wireless node while also preventing the wireless node from missing packets from the answerer. As stated above, in current systems the answerer is not required to send packets at the rate indicated by “ptime” from the offerer. That is, even though the offerer requests to receive packets at 20 millisecond (msec) intervals, the answerer can still send packets at 10 msec intervals. Therefore, in accordance with one embodiment, the offerer can also send preconditions that indicate that the offerer will only continue the session if the answerer sends packets at the requested rate. In accordance with one embodiment, after receiving the first parameter and the second parameter, the answerer responds with a “ptime” parameter equal to the “send-ptime” parameter sent from the offerer. Optionally, the answerer can also respond with a “send-ptime” parameter equal to the “ptime” parameter from the offerer.

In a second example of a negotiation process for initiating a VoIP session, the wired node 104 is an offerer and the wireless node 100 is an answerer (i.e., the wired node 104 requests the session and the wireless node 100 responds to the requests). In one embodiment, the wired node 104 sends both the first parameter indicative of the rate at which the wired node 104 wants to receive packets and the second parameter indicative of the rate at which the wired node 104 wants to send packets to the wireless node 100. If the first parameter and the second parameter are equal to each other, the wireless node 100 will respond with a “ptime” value equal to the first and second parameters sent from the wired node 104. This will ensure that the wireless node is sending and receiving packets at the same time interval. If the first parameter and the second parameter are not equal to each other, the wireless node 100 can either respond with a “ptime” value equal to the first parameter or the wireless node 100 can reject the offer (i.e., refuse the call).

In a second embodiment, the wired node only sends a first parameter indicative of the rate at which the wired node 104 wants to receive packets. When the wireless node receives only the first parameter and not also the second parameter, the wireless node responds with a “ptime” value that is equal to the rate at which the wired node wants to receive packets. By responding with an equal rate at which the wireless node wants to receive packets, the wireless node will be able to send and receive packets at the same rate.

In all of the examples above, the wireless node 100 optimizes the likelihood of having a send rate for audio packets that is equal to the receive rate for audio packets.

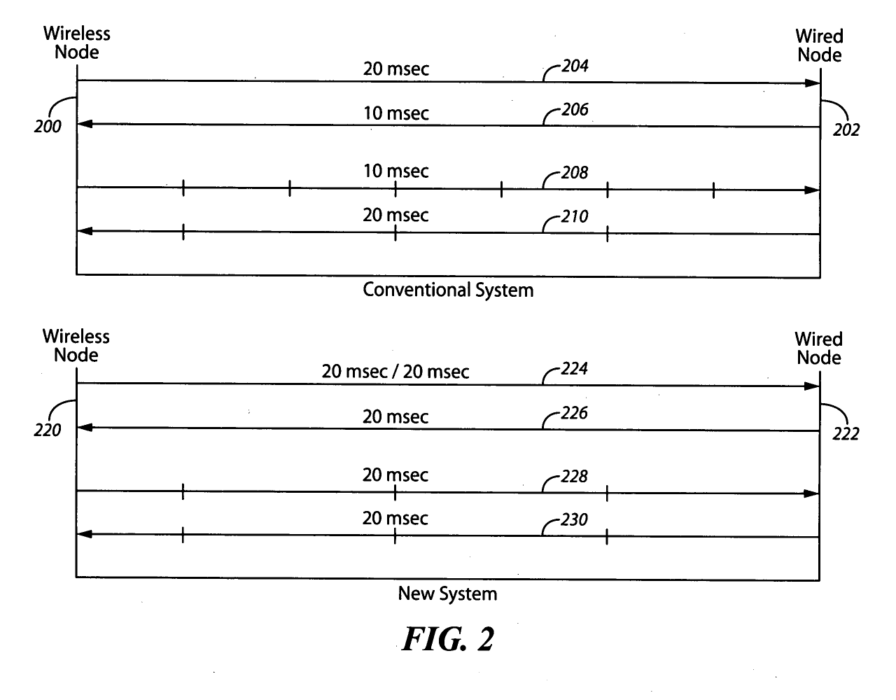

Referring to FIG. 2 a timing diagram is shown illustrating a negotiation for setting up a VoIP session between two nodes in accordance with one embodiment. In the example shown, a wireless node is an offerer and a wired node is an answerer. This is for exemplary purposes and other types of nodes also can operate in the same manner described.

In conventional systems, the wireless node 200 would send a request to initiate a session with the wired node. The wireless node 200 would also send a parameter 204 indicative of a rate at which the wireless node 200 would like to receive audio packets. For example, the wireless node 200 requests to receive audio packets every 20 msecs. In response, the wired node 202 responds with a parameter 206 indicative of the rate at which the wired node 202 would like to receive packets. For example, the wired node 202 requests to receive packets every 10 msecs. Once the session begins, the wired node 202 will send audio packets 210 to the wireless node 200 every 20 msecs. The wireless node 200 will send audio packets 208 to the wired node 202 every 10 msecs. As can be seen, the wireless node 200 has to wake up every 10 msecs to send audio packets, however, the wireless node 200 only receives audio packets every 20 msecs. This causes unnecessary drain on the battery of the wireless node 200.

In accordance with one embodiment of the present system, when the wireless node 220 sends a request to initiate a session with the wired node 222, the wireless node 220 sends a first parameter indicative of a rate at which the wireless node would like to receive audio packets and a second parameter indicative of a rate at which the wireless node would like to send audio packets 224. Preferably, the first parameter and the second parameter indicate rates that are equal to each other (e.g., 20 msecs for both rates). Next, the wired node 222 preferably responds with a rate for receiving packets 226 that is equal to the rate at which the wireless node 220 would like to receive packets.

Once the session begins, the wireless node 220 will send and receive packets at the same rate (e.g., every 20 msecs). Therefore, every time the wireless node wakes up, it can both send and receive a packet, thus optimizing the use of the battery power. In one embodiment, the wireless node 220 can also send a precondition to the wired node 222 that indicates the wireless node 220 will not start or continue the session unless the send and receive packet rates are equal.

Additionally, the following optional parameters can be used in setting the rates at the offering node and the answering node (i.e., endpoints). The optional parameters are:
The fastest rate that an endpoint can support.
The slowest rate or the max buffer size that an endpoint can support.
Discrete increment in packetization rate (i.e., change by 10 msec intervals only).
Max jitter buffers, Rate of polling, etc.

These parameters are sent to help the either the answering node or the offering node determine a transmission rate, if it was necessary. For example, the offering node might send the following parameters:
Send rate equal to 40 msecs.
Fastest rate the node can send packets is at 30 msecs.
Slowest rate the node can send packets is at 60 msecs.
Packets must be in intervals of 10 msecs.

The same parameters can also be sent by the offering node. The parameters are utilized by the offering node and the answering node to set send and receive rates that are agreeable to both the offering node and the answering node. As stated above, these are optional parameters used in accordance with some embodiments.

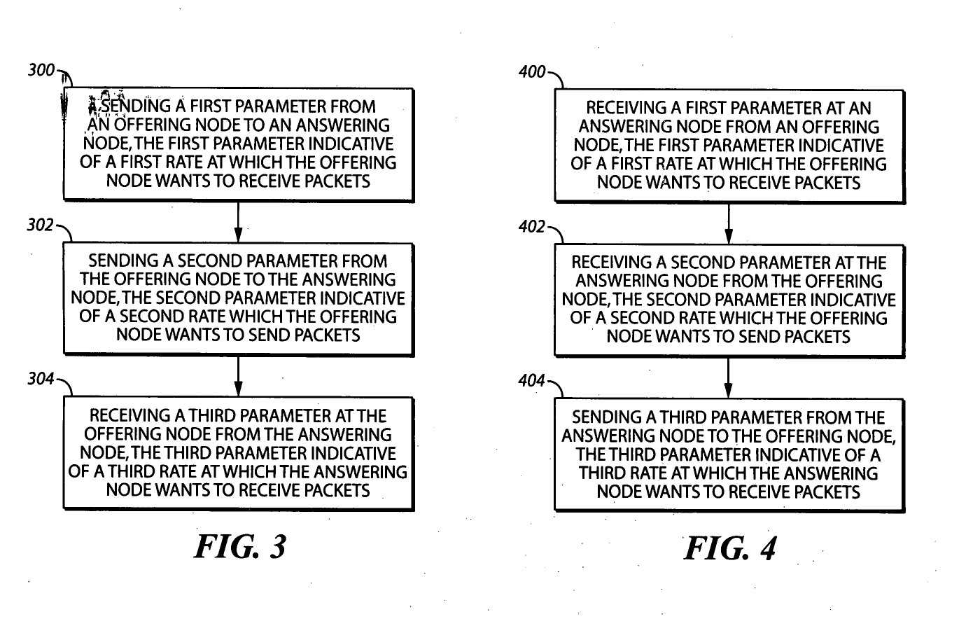

Referring to FIG. 3 a flow diagram is shown illustrating a method of synchronizing packet interval rates in accordance with one embodiment.

First in step 300, a first parameter is sent from an offering node to an answering node. The first parameter is indicative of a first rate at which the offering node wants to receive packets. The offering node is, for example, a wireless node within a VoIP system. The offering node is a node that wishes to send and receive audio packets through the VoIP system.

In step 302, a second parameter is sent from the offering node to the answering node. The second parameter is indicative of a second rate which the offering node wants to send packets. In the example where the offering node is a wireless node, it is advantageous for the wireless node to have send and receive rates that are equal to each other.

Next, in step 304, a third parameter is received at the offering node from the answering node. The third parameter is indicative of a third rate at which the answering node wants to receive packets. Preferably, the rate at which the answering node wants to receive packets is equal to the rate at which the offering node wants to receive packets.

Referring to FIG. 4 a flow diagram is shown illustrating a method of synchronizing packet interval rates in accordance with another embodiment.

First in step 400, a first parameter is received at an answering node. The first parameter is sent from an offering node and is indicative of a first rate at which the offering node wants to receive packets. In step 402, a second parameter is received at the answering node. The second parameter is sent from the offering node and is indicative of a second rate at which the offering node wants to send packets.

Following in step 404, the answering node sends a third parameter to the offering node. The third parameter is indicative of the rate at which the answering node wants to receive data. The rate at which the answering node wants to receive data is preferably equal to the rate at which the offering node wants to receive data.

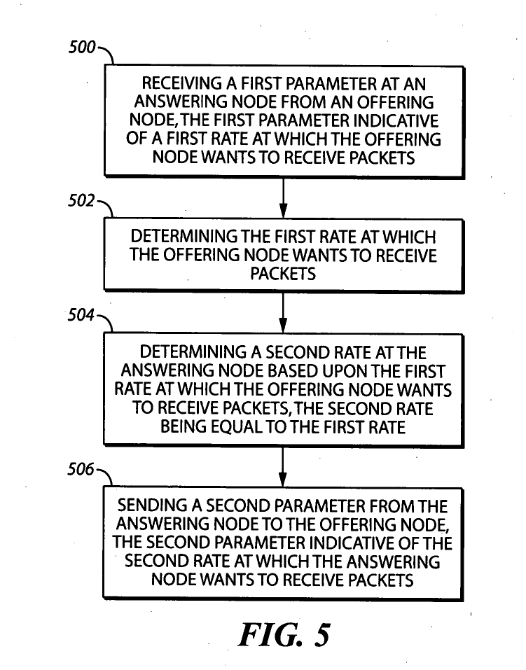

Referring next to FIG. 5 a flow diagram is shown illustrating a method of synchronizing packet interval rates in accordance with yet another embodiment.

In step 500, a first parameter is received at an answering node from an offering node. The first parameter is indicative of a first rate at which the offering node wants to receive packets. Next in step 502, the answering node determines the first rate at which the offering node wants to receive packets.

Following in step 504, the answering node determines a second rate based upon the first rate at which the offering node wants to receive packets. The second rate is equal to the first rate. In step 506, a second parameter is sent from the answering node to the offering node. The second parameter is indicative of the second rate at which the offering node wants to receive packets.

So configured, those skilled in the art will understand and appreciate that these teachings tend to ensure that two nodes communicating over a VoIP network will have equal send and receive packet interval rates. This, in turn, can greatly aid in assisting a node that is dependent upon a portable power supply to extend, or at least not unduly and prematurely deplete, the portable power supply while nevertheless tending to also ensure that all VoIP packets are both sent and received in a timely and reliable fashion.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A method of synchronizing packet rates in a voice over internet protocol system comprising:
sending a first parameter from an offering node to an answering node, the first parameter indicative of a first rate at which the offering node wants to receive packets; and
sending a second parameter from the offering node to the answering node, the second parameter indicative of a second rate which the offering node wants to send packets.

2. The method of synchronizing packet rates in a voice over internet protocol system of claim 1 wherein the first rate is equal to the second rate.

3. The method of synchronizing packet rates in a voice over internet protocol system of claim 1 further comprising sending a precondition from the offering node to the answering node, the precondition indicating that the offering node will only participate in a session if the answering node sends packets at the first rate.

4. The method of synchronizing packet rates in a voice over internet protocol system of claim 1 further comprising setting the send packet rate in the offering node to the second rate.

5. The method of synchronizing packet rates in a voice over internet protocol system of claim 1 further comprising:
receiving a third parameter at the offering node from the answering node, the third parameter indicative of a third rate at which the answering node wants to receive packets;
wherein the third rate at which the answering node wants to receive packets is equal to the second rate at which the offering node wants to send packets.

6. The method of synchronizing packet rates in a voice over internet protocol system of claim 5 further comprising processing the third parameter at the offering node and receiving audio packets from the answering node at the third rate.

7. The method of synchronizing packet rates in a voice over internet protocol system of claim 1 further comprising:
sending audio packets from the offering node to the answering node at the second rate; and
receiving audio packets from the answering node at the offering node at the first rate.

8. The method of synchronizing packet rates in a voice over internet protocol system of claim 7 wherein the first rate is equal to the second rate.

9. A method of synchronizing packet rates in a voice over internet protocol system comprising:
receiving a first parameter at an answering node from an offering node, the first parameter indicative of a first rate at which the offering node wants to receive packets; and
receiving a second parameter at the answering node from the offering node, the second parameter indicative of a second rate which the offering node wants to send packets.

10. The method of synchronizing packet rates in a voice over internet protocol system of claim 9 wherein the first rate is equal to the second rate.

11. The method of synchronizing packet rates in a voice over internet protocol system of claim 1 further comprising receiving a precondition at the answering node from the offering node, the precondition indicating that the offering node will only participate in a session if the answering node sends packets at the first rate.

12. The method of synchronizing packet rates in a voice over internet protocol system of claim 9 further comprising setting the send packet rate in the answering node to the first rate.

13. The method of synchronizing packet rates in a voice over internet protocol system of claim 9 further comprising:
sending a third parameter from the answering node to the offering node, the third parameter indicative of a third rate at which the answering node wants to receive packets;
wherein the third rate at which the answering node wants to receive packets is equal to the second rate at which the offering node wants to send packets.

14. The method of synchronizing packet rates in a voice over internet protocol system of claim 9 further comprising:
processing the second parameter at the answering node; and
setting a value of a third parameter at the answering node based upon the step of processing the second parameter, the third parameter indicative of a third rate at which the answering node wants to receive packets.

15. The method of synchronizing packet rates in a voice over internet protocol system of claim 9 further comprising:
receiving audio packets from the offering node at the answering node at the second rate; and
sending audio packets from the answering node to the offering node at the first rate.

16. The method of synchronizing packet rates in a voice over internet protocol system of claim 7 wherein the first rate is equal to the second rate.

17. A method of synchronizing packet rates in a voice over internet protocol system comprising:
receiving a first parameter at an answering node from an offering node, the first parameter indicative of a first rate at which the offering node wants to receive packets;
determining the first rate at which the offering node wants to receive packets;
determining a second rate at the answering node based upon the first rate at which the offering node wants to receive packets, the second rate being equal to the first rate; and
sending a second parameter from the answering node to the offering node, the second parameter indicative of the second rate at which the answering node wants to receive packets.

18. The method of synchronizing packet rates in a voice over internet protocol system of claim 17 further comprising setting the send packet rate in the answering node to the second rate.

19. The method of synchronizing packet rates in a voice over internet protocol system of claim 17 further comprising:
receiving audio packets from the offering node at the answering node at the second rate; and
sending audio packets from the answering node to the offering node at the first rate.

20. The method of synchronizing packet rates in a voice over internet protocol system of claim 17 further comprising:
receiving a third parameter at the answering node from an offering node, the third parameter indicative of a third rate at which the offering node wants to send packets;
processing the third parameter at the answering node; and
setting a value of the second parameter at the answering node based upon the step of processing the third parameter.
